(19) United States
(12) Patent Application Publication
(10) Pub. No.: US 2008/0190986 A1
(43) Pub. Date: Aug. 14, 2008

(54) Electric Nailing Mechanism

(76) Inventors: Chin-Hsiung CHANG, Taichung County (TW); Wen-Pin Lin, Taichung County (TW); Yan-Shiang Wang, Taichung County (TW)

Correspondence Address: Dr. BANGER SHIA, 102 Lindencrest Ct., Sugar Land, TX, 77479-5201, US

(21) Appl. No.: 11/673,550

(22) Filed: Feb. 9, 2007

(51) Int. Cl. B25C 1/06

(52) U.S. Cl. 227/107

(57) ABSTRACT

An electric nailing mechanism comprises a striker, an elastic member, one or two toothed bars, and a driving assembly. One end of the elastic member is fixed at one end of the striker. The toothed bars are disposed on a surface of the striker. The driving assembly comprises a screw, a drive gear wheel and one or two travel gears. The drive gear wheel is engaged with the screw and the drive gear wheel and the travel gears are coaxially connected together, so that the drive gear wheel and the travel gears can be rotated synchronously in the same direction. The travel gears are fan-shaped and are engaged with the toothed bars. By such arrangements, the driving assembly takes up a smaller space and the manufacture for the mechanism is much easier.

### BACKGROUND OF THE INVENTION

1. Field of the Invention

The present invention relates to an electric nailing mechanism, and more particularly to an electric nailing mechanism that is assembled in an electric tool and can automatically and repeatedly strike nails.

2. Description of the Prior Art

A conventional nailing mechanism for an electric tool performs striking action through a powerful striker that can move to and fro. Referring to FIG. 1, the conventional electric nailing mechanism comprises a striker 11, an elastic member 12, a first gear wheel 14, a second gear wheel 15, and a motor 19. One end of the elastic member 12 is fixed to the striker 11, and another end is fixed to a stationary end 13. The first gear wheel 14 is engaged with the second gear wheel 15, and two guide shafts 16 and 17 are disposed on the surface of the first gear wheel 14 and the second gear wheel 15 and are connected to the striker. When the output power of the motor 19 is transmitted to the first gear wheel 14 through a reduction mechanism 18, the striker 11 will be driven towards the stationary end 13, and the second gear wheel 14 will be rotated by the first gear wheel 15.

When the first gear wheel 14 and the second gear wheel 15 rotate to a predetermined position or angle, the restricting force between the guide shafts 16 and 17 will disappear, so that the striker 11 move forward to perform striking action by the restoring force of the elastic member 12.

The above-mentioned nailing mechanism must be provided with two gear wheels 14 and 15 that are transversely arranged and engaged with each other, so the transverse width of the gear wheel assembly at least equals to the sum of the diameter of the first gear wheel 14 and the second gear wheel 15, namely the width D1 as shown in FIG. 1. In addition, the electric nailing mechanism is required to have a space for installation of the reduction mechanism 18, so the two gear wheels 14 and 15 and the reduction mechanism 18 of the conventional electric nailing mechanism take up a relatively large space.

Moreover, the use of the reduction mechanism 18 increases the mechanical loss of the motor 19, which results in a reduction of the mechanical efficiency.

The conventional electric nailing mechanism can change the stroke length of the striker by changing the position of the guide shaft 16 and 17, but the position of the guide shaft 16 and 17 must be precisely calculated, or the striker can not perform striking action successfully if any one of the guide shaft 16 or 17 is not timely disengaged from the striker. In other words, the conventional electric nailing mechanism is difficult to design and to manufacture.

The present invention has arisen to mitigate and/or obviate the afore-described disadvantages.

### SUMMARY OF THE INVENTION

The primary objective of the present invention is to provide an electric nailing mechanism, wherein a striker is provided with one or two toothed bars that engage with a gear wheel assembly, a screw transmits power to the gear wheel assembly, and the gear wheel assembly is engaged with the toothed bars to drive the striker to move. It is noted that the gear wheel assembly includes a drive gear wheel and a travel gear, which are coaxially connected together. The drive gear wheel is round-shaped so as to engage with the screw. The travel gear is fan-shaped and is engaged with each toothed bar. When the gear wheel assembly rotates to a predetermined angle or position, the travel gears will disengage from the toothed bars completely. In other words, there will be no restricting force between the striker and the gear wheel assembly, so that the striker will be pushed to move forward by the restoring force of the elastic member. By such arrangements, the driving assembly takes up a smaller space and the manufacture for the mechanism is much easier.

### BRIEF DESCRIPTION OF THE DRAWINGS

FIG. 1 is an illustrative view of a conventional nailing mechanism;

FIG. 2 is a perspective view of a nailing mechanism in accordance with the present invention;

FIG. 3 is a perspective view of showing the structure of the nailing mechanism in accordance with the present invention;

FIG. 4 is a first operational view of the nailing mechanism in accordance with the present invention;

FIG. 5 is a second operational view of the nailing mechanism in accordance with the present invention;

FIG. 6 is a third operational view of the nailing mechanism in accordance with the present invention; and

FIG. 7 is a perspective view in accordance with the present invention of showing that the size of travel gears is changed.

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

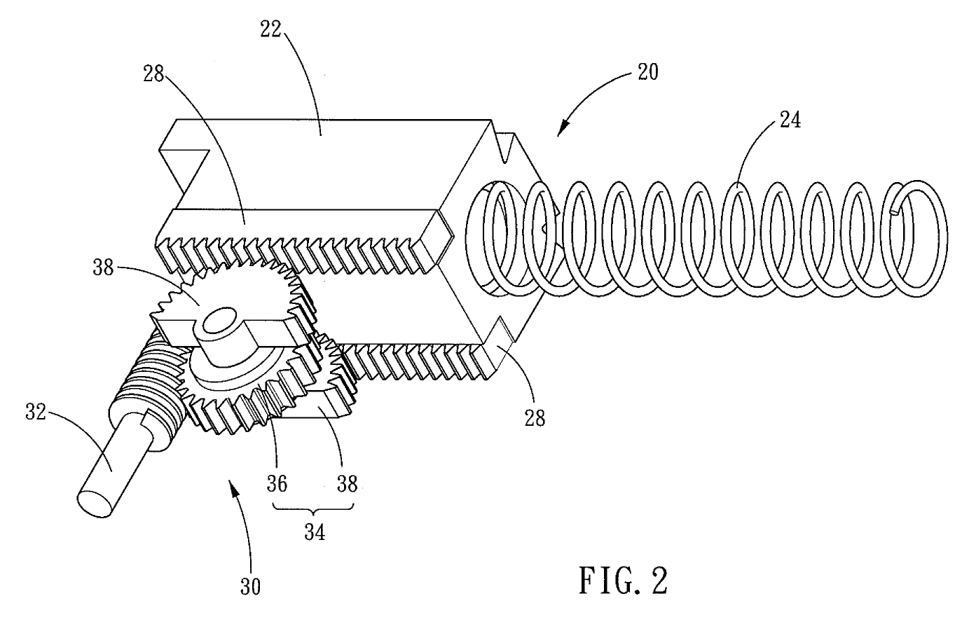

Referring to FIG. 2, a nailing mechanism 20 in accordance with the present invention is assembled in an electric tool (not shown) and is driven by a motor.

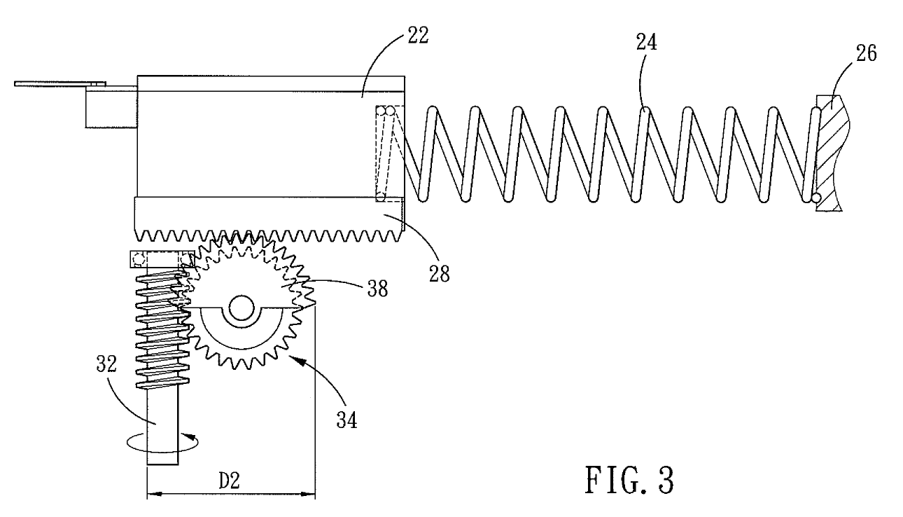

Referring to FIGS. 2 and 3, the electric nailing mechanism 20 comprises a striker 22 and an elastic member 24 with one end fixed at one end of the striker 22. The other end of the elastic member 24 is fixed to a stationary end 26. On a surface of the striker 11 is disposed one or two toothed bars 28, and there are two toothed bars 28 in the FIG. 2.

A driving assembly 30 is disposed on a surface of the striker 11 and engages with the toothed bars 28. The driving assembly 30 comprises a screw 32 and a gear wheel assembly 34. The screw 32 is driven to rotate continuously by motor power. The gear wheel assembly 34 includes a drive gear wheel 36 and one or two travel gears 38. The drive gear wheel 36 and the travel gears 38 are coaxially connected together through their central holes, so that the drive gear wheel 36 and the travel gears 38 can be rotated synchronously in the same direction.

It is noted that the drive gear wheel 36 is round-shaped and the whole periphery of the drive gear wheel 36 is toothed, so that it can engage with the screw 32. Each of the travel gears 38 is fan-shaped and only the fan-shaped periphery is toothed. The fan-shaped periphery of each of the travel gears 38 is engaged with each toothed bar 28.

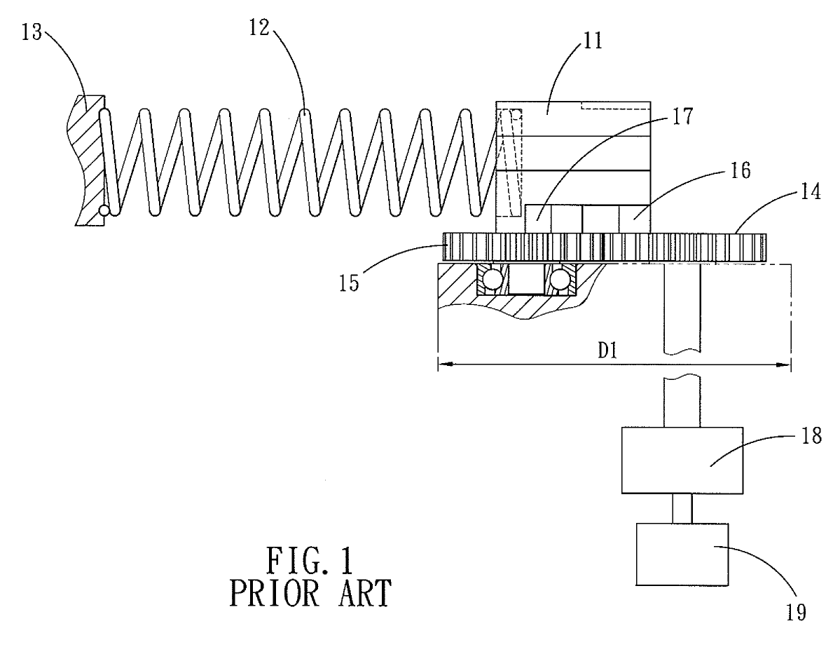

Referring to FIG. 3, the transverse length of the driving assembly 30 of the present invention is the sum of the diameter of the drive gear wheel 36 or the travel gear 38 and the axial diameter of the screw 32, namely the D2 as shown in FIG. 3. By comparing FIG. 1 with FIG. 3, we can see that the diameter of the screw is definitely smaller than that of the gear wheel if the diameters of the gear wheels in FIG. 1 and FIG. 3 are the same, so D2 is smaller than D1. In other words, the space occupied by the driving assembly of the present invention is obviously smaller than the conventional one.

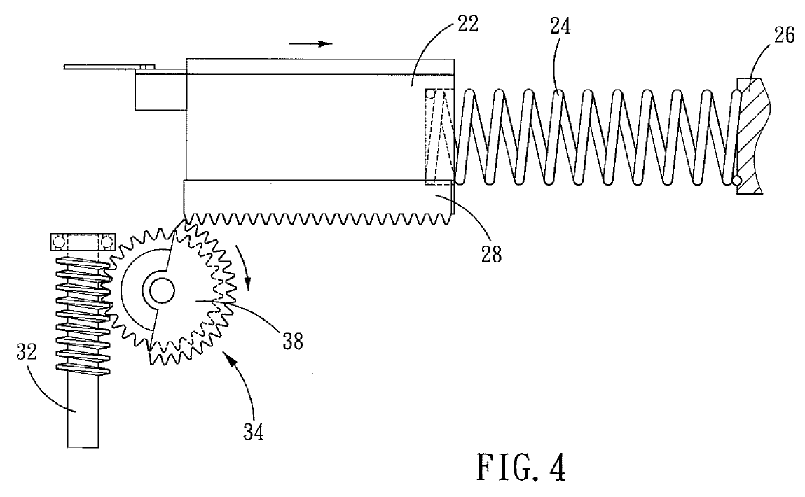

Referring to FIGS. 3 and 4, when the screw 32 rotates to drive the gear wheel assembly 34, the travel gears 38 that are engaged with the toothed bars 28 will drive the striker 22 to move towards the stationary end 26, and at this movement, the elastic member 24 is compressed and generates restoring force.

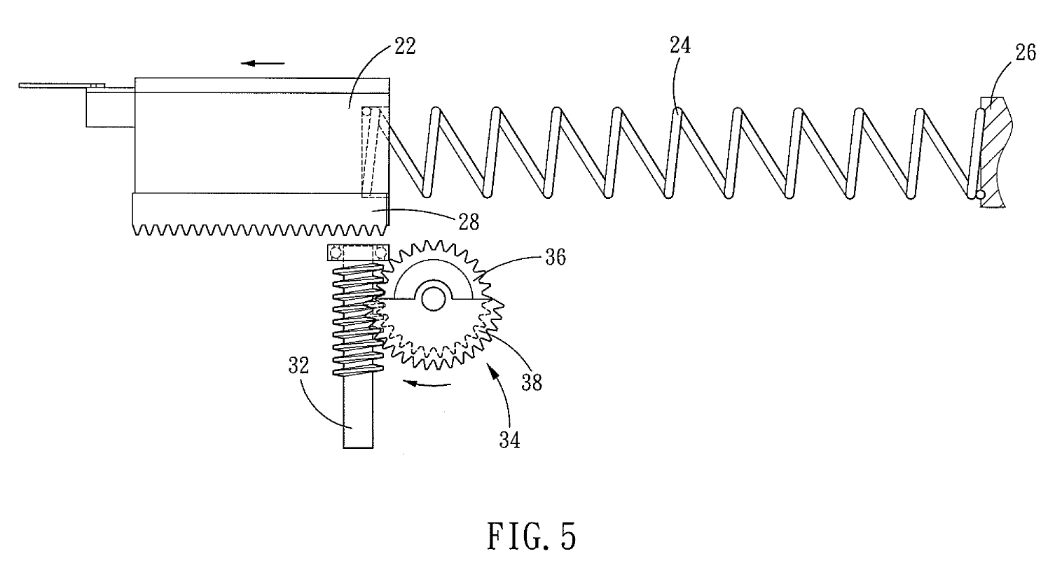

Referring to FIG. 5, when the gear wheel assembly 34 rotates to a predetermined angle or position, the travel gears 38 will disengage from the toothed bars 28 completely. In other words, there will be no restricting force between the striker 22 and the gear wheel assembly 34, so that the striker 22 will be pushed to move forward by the restoring force of the elastic member 24. It is noted that the drive gear wheel 36 does not contact the surface of the striker 22, so that the striker 22 can make a quick strike effortlessly.

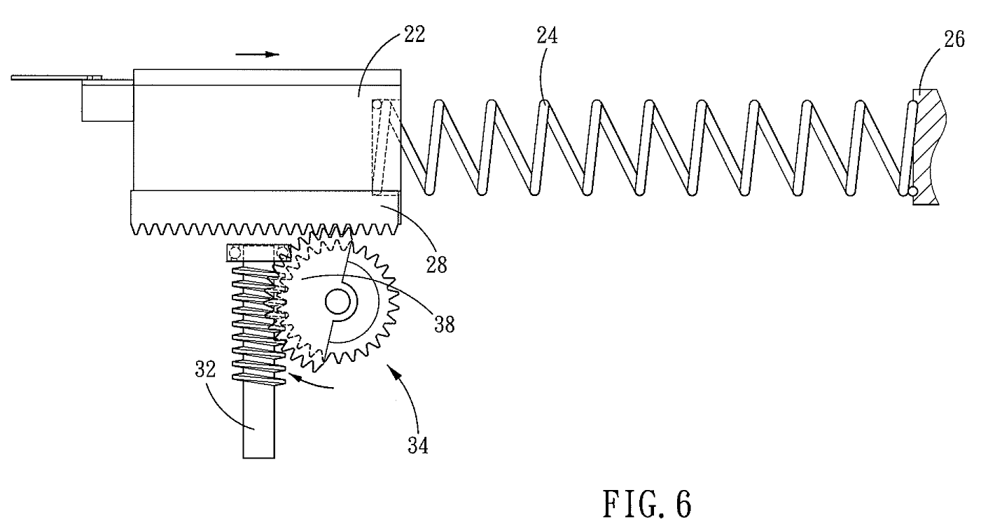

Referring to FIG. 6, the travel gears 38 will be engaged with the toothed bars 28 again due to the continuous rotation of the screw 32 and the gear wheel assembly 34, so that the striker is driven to move towards the stationary end 26 and compresses the elastic member 24 in order to accumulate striding force for next strike.

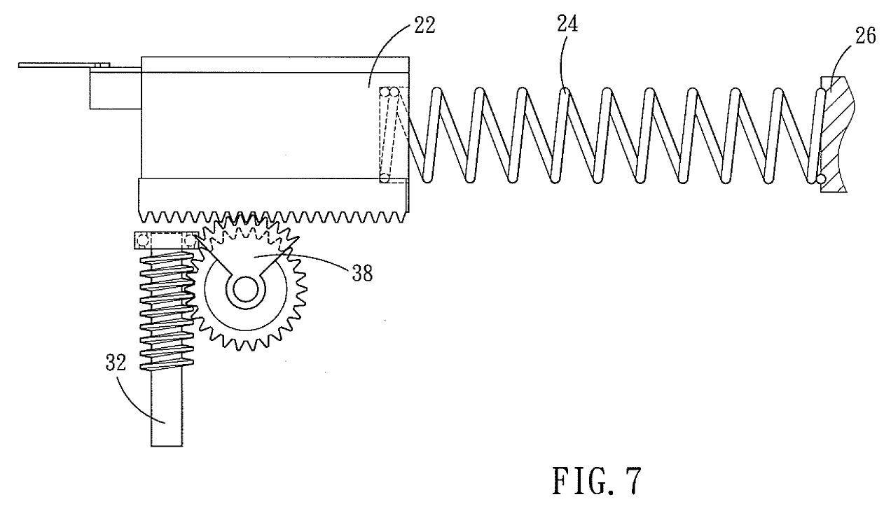

Referring to FIG. 7, when the central angle of each of the travel gear 38 is changed, the circumferential length of the fan-shaped side is much shorter than that of the abovementioned embodiment, and the circumferential length of the tooth-shaped portion is reduced relatively, so the stroke length of the striker 22 driven by the travel gears 38 is shortened. In other words, simply changing the specification of travel gear 38 can change the stroke length. The adjustment of the stroke length and the manufacture for the travel gears 38 are much easier.

To sum up, from the above-mentioned embodiments, the present invention not only takes up a relatively smaller space, but also needs no additional reduction mechanism and further can reduce the loss of mechanical energy, so as to improve the mechanical efficiency.

While we have shown and described various embodiments in accordance with the present invention, it is clear to those skilled in the art that further embodiments may be made without departing from the scope of the present invention.

1. An electric nailing mechanism for automatically and repeatedly striking nails being assembled in an electric tool, comprising:
a striker;
an elastic member fixed to one end of the striker;
two toothed bars disposed on a surface of the striker;
a gear wheel assembly including a drive gear wheel and two travel gears, the drive gear wheel being disposed between and coaxially with the travel gears, the travel gears being sectorial and engaged with the tooted bars, the drive gear wheel being round-shaped; and
a screw engaged with the drive gear wheel;
the two parallel toothed bars being disposed on a surface of the striker, and the two travel gears being coaxially connected with the drive gear wheel and then being engaged with the two toothed bars;
when the travel gear is engaged with the toothed bar, it drives the striker to move to perform striking action, and when the travel gear is disengaged from the toothed bar, the striker is released and returned to its original position under a restoring force of the elastic member.

2. (canceled)
